(19) United States
(12) Patent Application Publication
(10) Pub. No.: US 2008/0026192 A1
(43) Pub. Date: Jan. 31, 2008

(54) Composite thermal transfer, method of making same and label webs

(76) Inventor: Brian L. Halliday, Hickory, NC (US)

Correspondence Address: PAXAR AMERICAS, INC.;ATTN: JOSEPH J. GRASS, 170 MONARCH LANE, MIAMISBURG, OH, 45342, US

(21) Appl. No.: 11/492,751

(22) Filed: Jul. 25, 2006

(51) Int. Cl. B32B 3/00

(52) U.S. Cl. 428/204

(57) ABSTRACT

There are disclosed a composite thermal transfer including a thermal transfer which incorporates a label such as a hologram, a composite label that can be incorporated into a composite thermal transfer and methods of making a composite thermal transfer.

### BACKGROUND OF THE INVENTION

This invention relates to thermal transfers and method of making same and to label webs for use in making composite thermal transfers.

1. Field of the Invention

2. Brief Description of the Prior Art

The following patent documents are made of record: U.S. Pat. No. 6,521,327; Published Application US2004/0179083; Published application US2005/0100689; Provisional U.S. application 60/430,216; and Provisional U.S. application 60/453,661.

FIGS. 13 and 14 show a prior art web of hologram labels. These labels were initially releasably adhered at their face side to a pressure sensitive adhesive-coated carrier web. The pressure sensitive adhesive temporarily held the hologram labels to the carrier web. The back side of the hologram labels had a coating of heat-activatable adhesive. When the labels were delaminated from the pressure sensitive adhesive-coated carrier web, the pressure-sensitive adhesive remained with the carrier web. The hologram label was adhered to the garment by placing the back of the hologram label against the garment and applying heat and pressure to bond the hologram label to the garment by means of the heat-activatable adhesive.

### SUMMARY OF THE INVENTION

An embodiment of a composite thermal transfer includes a thermal transfer and a label adapted to be transferred as a unit onto a suitable receptive surface such as a garment. The composite thermal transfer may be comprised of a carrier preferably in the form of a web. The carrier either has a release coating initially or the release coating can be applied as part of the transfer making method. There can be an optional protective coating over the release coating, if desired. The protective coating is transparent as is typical. One or more layers of printing can be applied over any such a protective coating. If there is no protective coating the printing or printed layer or layers can be applied into contact with the release coating. In order to accommodate an added label to the thermal transfer, a free zone is provided which is free of any printing. A heat-seal or heat-activatable adhesive is applied over the printing, but not in the free zone. A label is placed in the free zone and is adhered to the protective coating or alternatively to the release coating at the free zone. As such, the label is implanted and forms a part of a composite thermal transfer. When the composite transfer is to be applied by heat and pressure to, for example, a garment, the thermal transfer and the label are simultaneously transferred onto the garment, and both the printing on the transfer and the printing on the label are part of the transferred image. The label can be provided with suitable printing and it is most preferred that the printing be a hologram. When the label includes a hologram, the transferred image is not only attractive but the garment is easier to authenticate because a composite transfer image is relatively difficult to replicate. An embodiment also includes method of making a composite thermal transfer.

The printed label which is applied to the free zone can have various constructions according to the selected method used to implant the printed label into the free zone. One embodiment of a composite printed label includes a printed label having both heat-activatable adhesive and pressure sensitive adhesive, wherein the pressure sensitive adhesive is used to adhere the printed label to the thermal transfer and the heat-activatable adhesive is used to adhere the label to the garment or other substrate to which the transfer and the printed label are to be applied. The printing and any protective coatings are elastic or stretchable in the event the composite thermal transfer is to be applied to a stretchable substrate such as a garment because the garment may stretch while being worn by the user and the garment may be subject to repeated washings in commercial washing machines or in dry cleaning machines.

The label is suitably adhered to the thermal transfer to provide the composite thermal transfer, and the preferred structure to obtain adherence is most preferably by a very thin, clear coating of pressure sensitive adhesive.

The label may be the same size and shape, that is, congruent with the free zone, or the label may be smaller than the free zone, or the label may be of a different shape than the free zone, or the label may be wholly or partly larger than the free zone so as to wholly or partly overlap the marginal edge or edges of the thermal transfer. When the label overlaps the thermal transfer it is preferred that there is no printing at the overlap because at least some printing on the thermal transfer would be superimposed over the printing on the label once the composite thermal transfer has been applied to the substrate, e.g., the garment.

### BRIEF DESCRIPTION OF THE DIAGRAMMATIC DRAWINGS

FIG. 1 is a plan view of a composite image on fabric such as a garment resulting from use of the composite thermal transfer;

FIG. 2 is a flow diagram depicting a method by which the composite thermal transfer can be made;

FIG. 3 is a sectional view taken generally along line 3-3 of FIG. 2;

FIG. 4 is a top plan view of a web of composite labels for use in making a composite thermal transfer in accordance with an embodiment;

FIG. 5 is a sectional view taken along line 5-5 of FIG. 4;

FIG. 6 is a diagram showing a method making a composite thermal transfer using labels illustrated in FIGS. 4 and 5;

FIG. 7 is a top plan view of a web of composite labels for use in a method of making composite thermal transfers in accordance with another embodiment;

FIG. 8 is a sectional view taken along line 8-8 of FIG. 7;

FIG. 9 is a diagram showing a method of making the composite thermal transfer using labels illustrated in FIGS. 6 and 7;

FIG. 10 is a top plan view of a web of composite labels for use in a method of making a composite thermal transfer in accordance with yet another embodiment;

FIG. 11 is a sectional view taken along line 11-11 of FIG. 10;

FIG. 12 is a diagram showing a method making a composite thermal transfer using labels illustrated in FIGS. 10 and 11;

FIG. 13 is a top plan view of a web of a prior art composite hologram labels for use in a method of making a composite thermal transfer in accordance with still another embodiment;

FIG. 14 is a sectional view taken along line 14-14 of FIG. 13; and

FIG. 15 is a diagram showing a method of making a composite thermal transfer using a prior art label web illustrated in FIGS. 13 and 14.

### DETAILED DESCRIPTION OF THE PREFERRED EMBODIMENTS

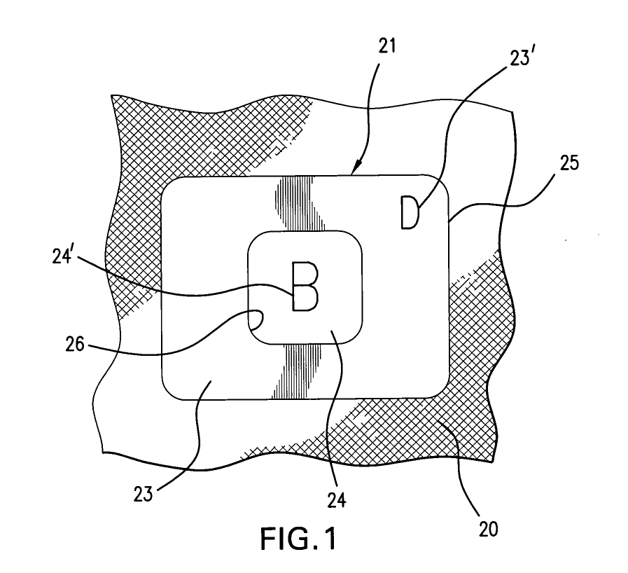

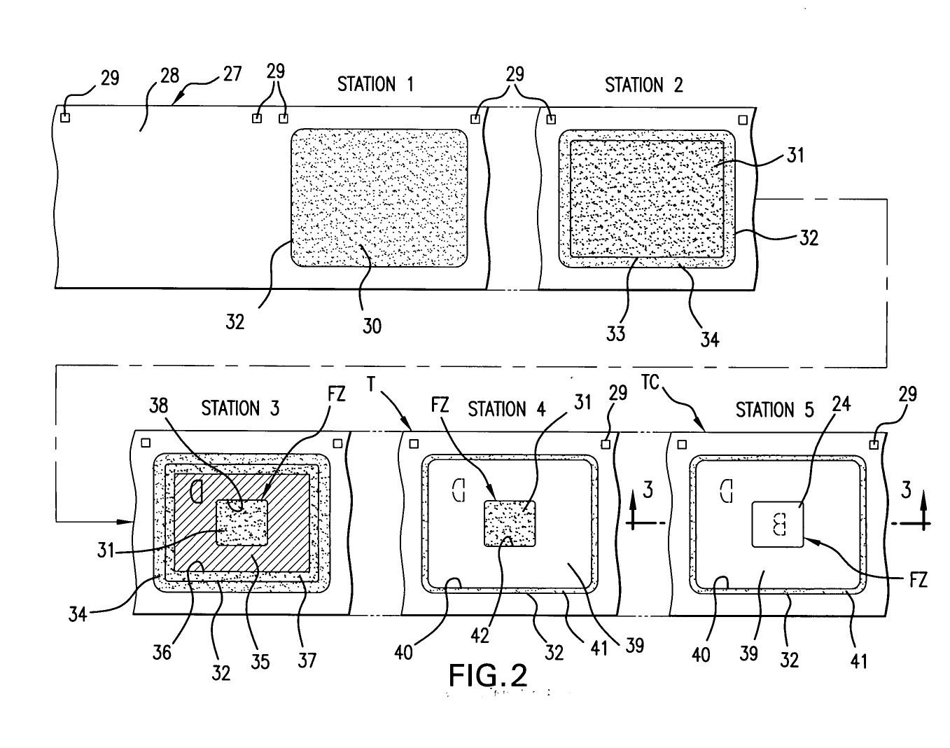

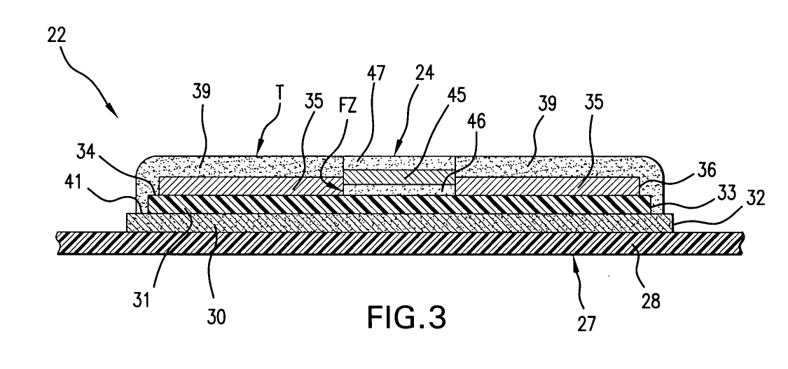

With reference to FIG. 1, there is shown a piece of fabric, for example a part of a garment 20, bearing a composite thermal transfer image generally indicated at 21. The image 21 can be transferred onto the garment 20 from a composite thermal transfer as generally indicated at 22 in FIGS. 2 and 3 according to one embodiment, for example. The image 21 includes a transferred image 23 and a printed label 24. The printed image 23 is shown to be generally rectangular, but it can be of any desired shape, and likewise the label 24 can be of any desired shape either totally surrounded by the printed image 23 or at an outer border thereof. Preferably the label 24 does not overlap the printed image 23. The printed image 23 can include any desired printing such as graphics, bar codes, words or a combination thereof. The printed image 23 is shown in a normally visual representation and the letter “D” illustrates this. The image 23 has an outer boundary 25 and an inner boundary 26. The area within the boundary 26 is shown to be completely filled with the label 24, as is preferred. However, the label can be smaller than the inner boundary 26 in which case the portion of the garment between the label 24 and the boundary 26 would be visible.

FIG. 2 shows a method of making the flexible transfer 22 which starts out with a flexible carrier generally indicated at 27 preferably in the form of a carrier web 28. The web 28 can have registration marks 29. The web 28 can start out as a plain web as shown at the upper left of FIG. 2. When the web 28 reaches STATION 1, a coating of release material 30, typically silicone, can be applied in a pattern generally similar in shape to the printing of the thermal transfer but slightly more extensive as will be seen hereinafter. The coating 30 is shown by light stippling. Alternatively the entire web 28 can be pre-coated with a release coating if desired, in which case STATION 1 can be omitted. The web 28 then passes successively to STATIONS 2 through 5 either in one machine or in more than one machine. Other stations can be added for example if there is more than one printing station or protective coating applying station.

At STATION 2, a protective coating 31 is applied over the release coating 30. The protective coating 31 is depicted by moderately heavy stippling. The shape of the area of the protective coating 31 is similar to the shape of the printing to be applied, except the release coating is at least slightly larger than the shape of the protective coating 31. The release coating is shown to have a boundary 32 and the protective coating is shown to have a boundary 33. There is a border 34 of release coating outside the boundary 33. If the release coating had been continuous across and along the entire longitudinally extending carrier web 28, it is apparent that the border would be larger than shown and extend to the edges of the web 28.

At STATION 3, printing 35 is applied over the protective coating 31. The printing 35 can be in an area indicated at 35 within a boundary 36. The printing is in reverse as is shown by the exemplary letter “D” in FIG. 2. There is a border 37 between the boundary 33 and the boundary 36. The border 37 is comprised of the protective coating 31. The printing 35 also has a “free zone” FZ defined by a boundary 38 which is free of printing 35. Therefore, the protective coating 31 is visible in the free zone FZ at STATION 3 in FIG. 2.

At STATION 4, a coating of heat-seal or heat-activatable adhesive 39 is applied completely over the printing 35 to an outer boundary 40 to form a flexible thermal transfer T. The boundary 40 is preferably within the outer boundary 32, if any, to define a border 41. Therefore, both the printing 35 and the protective coating 31 are completely covered by the adhesive 39 as is evident in FIG. 3 as well. It is apparent that the free zone FZ at STATION 4 is the same size as in STATION 3. The inner boundary of the adhesive 39 is indicated at 42. The inner boundary 38 of the printing 35 and the inner boundary 42 of the adhesive 39 are preferably congruent. The protective coating 31 is visible in the free zone FZ at STATIONS 3 and 4.

At STATION 5, a previously printed label 24 has been applied at the free zone FZ. The previously printed label 24 was printed normally (that is, not in reverse) and is applied with its printed face preferably over and against the protective coating 31 and facing the carrier 28 at the free zone FZ or directly onto the release coating or material 30 if no protective coating is used. When the composite thermal transfer 22 is applied to the substrate 20 by heat and pressure, the printing 35, the protective coating 31, the adhesive 39 and the label 24 are transferred as a unit, and the printing 23 including both the exemplary letter “D” and the exemplary letter “B” appear as normally readable (not in reverse). The expression that the label is “over” the release coating does not mean that there cannot be an intervening protective coating.

With reference to FIG. 3, there is shown the composite thermal transfer 22 including the thermal transfer T and the composite label 24 implanted in the free zone FZ. As shown, the heat-seal or heat-activatable adhesive 39 covers the printing 35 and the border 34 of the protective coating 31. The label 24 preferably has printed label material 45, a preferably thin, pressure sensitive or tacky adhesive coating or layer 46, and a heat-activatable adhesive layer 47 which is non-tacky when dry. The label 24 is shown to completely fill the free zone FZ as is preferred. The adhesive 46 is adhered to the protective coating 33 and the adhesive 47 is disposed on the outer part of the composite label 24 When the composite thermal transfer 22 is applied to, for example, a garment 20 using heat and pressure, the adhesive 39 and the adhesive 47 are against the garment 20 and the printing 36, the protective coating 31 and the composite printed label 24 are thereby adhered to the garment 20 permanently. The protective coating 30 helps protect the resultant image shown diagrammatically in FIG. 1 during repeated washing or dry cleaning.

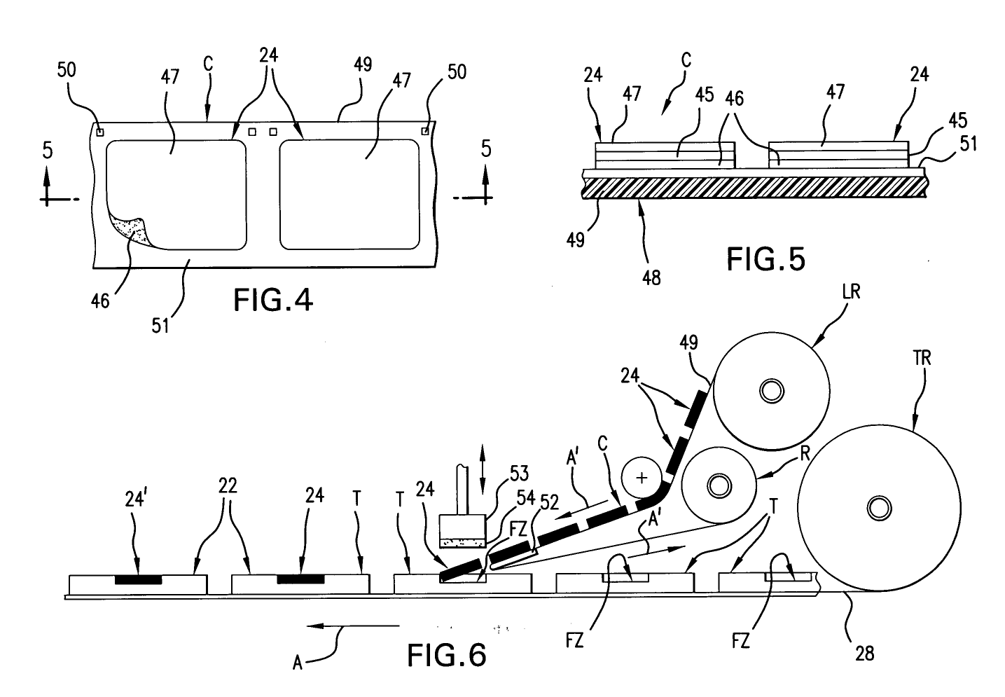

FIGS. 4 and 5 show a composite web C of composite labels 24 on a carrier web 49. The carrier web 49 preferably has registration marks 47 which aid in registering the labels 24 as they are applied to the thermal transfers 22. The labels 24 are releasably adhered to a release coating 50 on the carrier web so that the labels 24 may be readily peeled from the carrier web 49 when required. The label 24 shown in FIG. 3 can be made using the composite label web C shown in FIGS. 4 and 5 for example. The composite label web C includes a carrier generally indicated at 48 in the form of the carrier web 49 and the composite labels 24. The composite labels 24 include a preferably uniform coating of pressure sensitive or tacky adhesive 46 releasably adhered to the release coating 51, a label 45 to which the pressure sensitive adhesive 46 adheres, and a preferably uniform coating of a heat-activatable adhesive 47. The adhesive 47 is dry to the touch so that the composite web C can be readily wound into a roll or disposed in a fan-fold arrangement.

As shown in FIG. 6, the web of transfers T can be pulled from a transfer roll TR in the direction of arrow A. As the composite labels 24 are advanced from label roll LR by drawing the carrier web 49 about an edge of the peel plate 52 and preferably rewinding the carrier web 49 into a roll R, the composite labels 24 are dispensed into in the free zone FZ of the transfers T, and the labels 24 are positioned in place in the free zone FZ. An applicator head 53 having a preferably resilient pad 54 applies pressure to the labels 24 successively to cause the adhesive 46 to hold the label 24 in place.

The positioning on the web 28 is synchronized with the positioning of the web C by respective registration marks 29 and 50. The webs 28 and 49 can advance continuously at different speeds in the directions of arrows A′ and A respectively or one or both of the webs 28 and 49 can be advanced intermittently. The completed composite thermal transfers 22 can be wound into a roll or folded into a fan-fold arrangement.

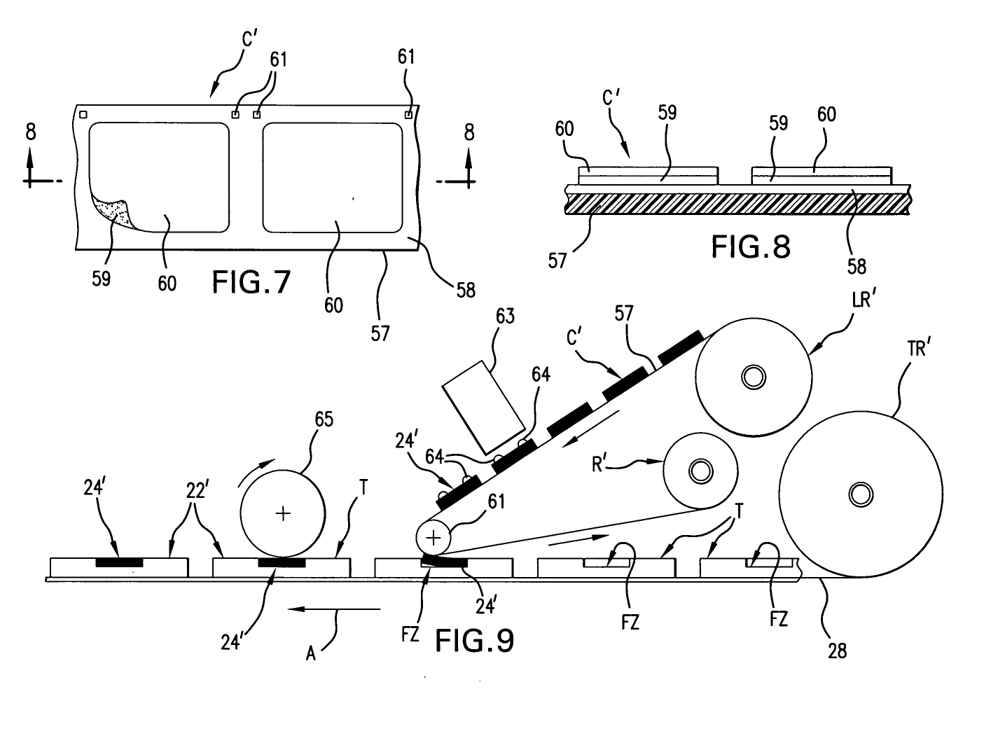

With reference to FIGS. 7 and 8, a flexible composite label web is generally indicated at C′. The web C′ includes a carrier in the form of a flexible carrier web 57 having a release coating. Adhered to the carrier web 57, which can be made of paper or other suitable material such as plastic film, is a uniform release coating 58 of silicone or other suitable material. Coated onto the release coating 58 is a heat-activatable adhesive 59. A label 60, for example, a hologram, is adhered to the coating 59. The carrier web 57 also carries registration marks 61.

With reference to FIG. 9, the transfers T move in the direction of arrow A as the transfer web 28 is paid out of the supply roll TR′. The composite label web C′ is paid out of label roll LR′ toward a turning roll 61. A coating head 63 coats or prints pressure sensitive adhesive 63 in either a pattern or spots as shown or uniformly on the surface of the printed label 60. When the adhesive 63 is applied to the label 60, a flexible composite label 24′ begins to exist. As the carrier web 57 passes about the turning roll 61 the composite label 24′ is released from the carrier web 57 and the spent carrier web 57 is wound into a roll R′. As shown, the composite label C′ is released into the free zone FZ. As the composite thermal transfer 22′ moves beyond the turning roll 61, a pressure roll 65 presses the composite label 24′ into place at the free zone FZ in the transfer T. Instead of applying the pressure sensitive adhesive 64 as indicated above, the pressure sensitive adhesive can alternately be applied in the free zones FZ between the roll TR′ and the turning roll 61 by a coating head like the coating head 63.

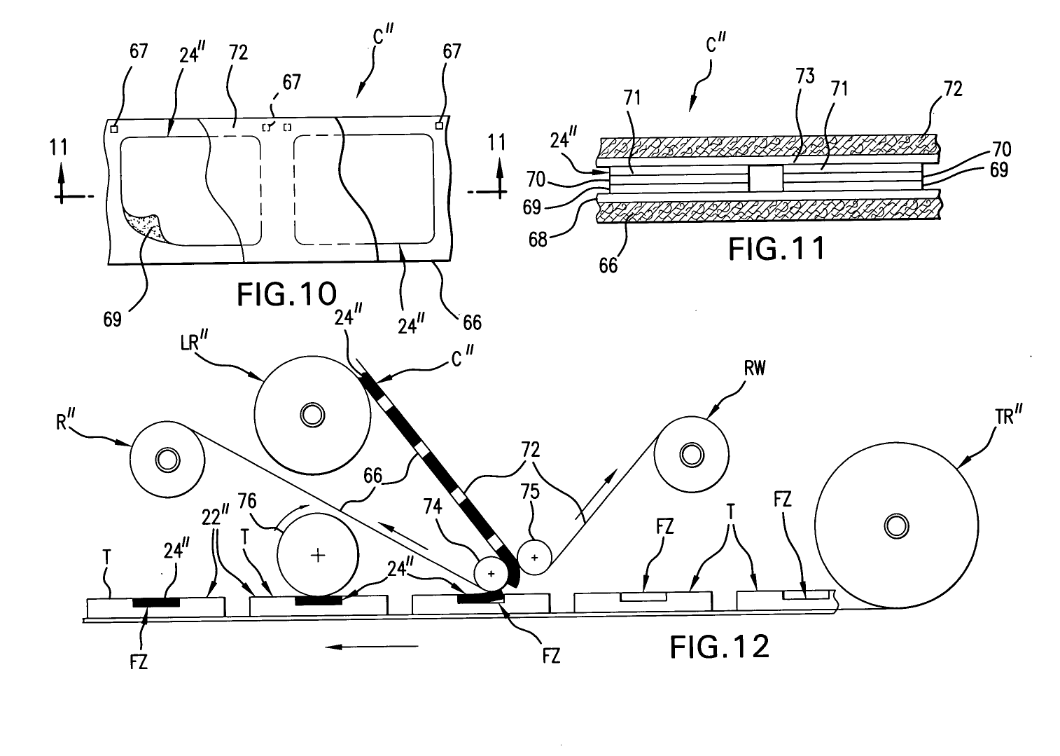

With reference to FIGS. 10 and 11, there is shown a composite label web C″ including a flexible carrier web 66 with registration marks 67. The carrier web 66 can include a release coating 68. There is a preferably uniform coating of heat-activatable adhesive 69 on the release coating 68. A label 70 is adhered to the adhesive 69. A preferably uniform coating of pressure sensitive adhesive 71 is applied over the label 70 to provide a composite label 24″ and a flexible liner web 72 with a release coating 73 is releasably adhered to the adhesive 71. The composite label web C″ can be used in the method according to FIG. 12.

FIG. 12 shows the transfers T being paid out of the supply roll TR″. The composite label web C″ is paid out of the supply roll LR″ and the web 66 with the release coating 68 is delaminated at a laminating roll 74 and passes to a roll R″ while the release liner web 72 passes about a roll 75 and is wound into a roll RW. The composite labels 24″ which have been peeled from the webs 66 and 72 are applied to the free zones FZ. The adhesive 71 adheres the composite labels 24″ to the transfers T and a pressure roll 76 can be used to press the composite label 24″ onto the transfer T to improve adherence.

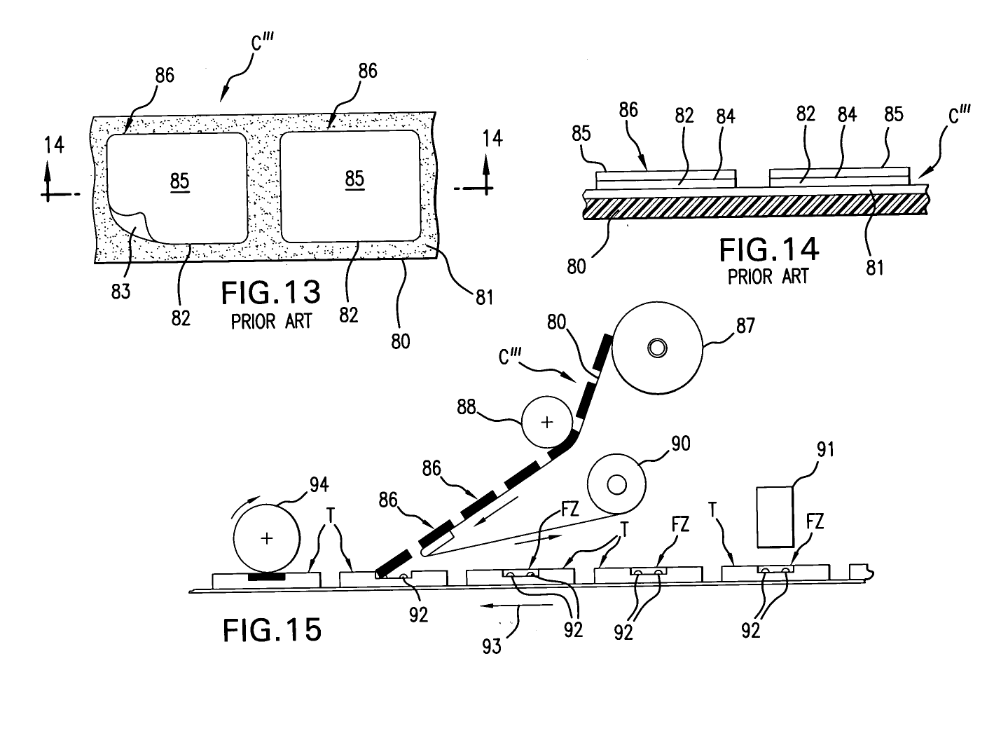

With reference to FIGS. 13 AND 14, there is shown a prior art composite label web C′″ having a transparent carrier web 80 having a coating of pressure sensitive adhesive 81. The adhesive 81 lightly or weakly adheres labels, such as, hologram labels 82 to the carrier web 81. The adhesive 81 contacts the face or printed side 83 of the labels 82. The back side 84 is adhered to a coating of heat-activatable adhesive 85. The label 82 and the heat-activatable adhesive 85 provides a composite label 24′″.

FIG. 15 shows the transfers T as having been paid out of a thermal transfer roll (shown in FIG. 9 for example). The composite label web C′″ is paid out of a supply roll 87 and passes partially around a roll 88. The carrier web 80 passes about a peel plate 89 and is wound into a roll 90.

A coating head 91 coats or prints clear pressure sensitive adhesive 92 in either a pattern or spots as shown or uniformly in the free zone FZ over the protective coating 31 FIGS. 2 and 3 or directly onto the release coating 30 if no protective coating is provided. The web of thermal transfers T may proceed in the direction of arrow 93 and the composite label 24′″ is dispensed over or onto the free zone FZ. The pressure sensitive adhesive 92 holds the face side 83 of the label 24′″ to the transfer T at the free zone FZ to provide a composite thermal transfer 22′″. Roll 94 can press the composite label 86 in place.

There can be more than one free zone FZ and more than one label 24, 24′, 24″ or 24′″ per composite thermal transfer 22, 22′, 22″, or 22′″, if desired. The methods of making the composite thermal transfer 22, 22′, 22″ or 22′″ can be performed in one machine, or one or more but less than all of steps at STATIONS 1 through 5 can be performed in different machines. The thermal transfer webs, the composite label webs, and the composite thermal transfer webs can be of multiple widths. The printing of the transfers T can be in different layers and colors, and there can also be protective layers between the printing or printed layers.

The transfers T can be made according to the transfer making process for printing in fixed printing zones disclosed in co-owned printed patent publication identified as Pub. No. US2004/0179083, the disclosure of which is incorporated herein by reference, and materials such as ink, the adhesive, protective coatings and release coatings can be as described in that printed patent publication. Other disclosures of materials that may be employed in making transfers are disclosed in U.S. Pat. No. 6,521,327.

The composite thermal transfers C, C′, C″ and C′″, the labels 24, 24′, 24″ and 24′″, the transfers T and the various ink, protective and adhesive coatings are all preferably flexible, and the transferred image 21 is elastic and stretchable together with the garment to which the image 21 is applied. All the transferred ink, adhesive and coatings are preferably elastic enough so that the image 21 does not crack when the fabric 20 is stretched, washed or dry cleaned.

All the labels variously referred to in the different embodiments as 24, 45, 60, 70 and 82 together with their associated heat-activatable coatings are preferably flexible.

In all the foregoing embodiments, if the composite thermal transfers 22, 22′, 22″ and 22′″ are made in multiple widths, they can be slit into single width webs. In any event, these composite thermal transfers can be wound into rolls for shipment to customers.

Other embodiments and modifications of the invention will suggest themselves to those skilled in the art, and all such of these as come within the spirit of this invention are included within its scope as best defined by the appended claims.

I claim:

1. Method of making a composite thermal transfer, comprising:
providing a carrier wherein one side of the carrier has a release coating;
printing in reverse over the release coating but leaving a free zone,
applying adhesive over the printing outside the free zone, and
adhesively adhering a printed label facing the carrier at the free zone.

2. Method as defined in claim 1, wherein the printed label includes a hologram.

3. Method of making a composite thermal transfer, comprising:
providing a carrier wherein one side of the carrier has a release coating,
applying a protective coating against the release coating,
printing in reverse over the protective coating but leaving a free zone,
applying heat-activatable adhesive over the printing outside the free zone, and
thereafter adhering a printed label at the free zone with the printed label facing the protective coating.

4. Method as defined in claim 3, wherein the printed label is adhesively adhered to the protective coating.

5. Method as defined in claim 3, wherein the label is the same size and shape as the free zone.

6. Method as defined in claim 3, wherein the label is smaller than the free zone.

7. Method as defined in claim 3, wherein the label extends outwardly of the free zone and overlaps the thermal transfer.

8. Method of making a composite thermal transfer web, comprising:
providing a web of thermal transfers, at least some of the transfers containing printing in reverse with a free zone which is free of printing, and
adhering a printed label to the transfer in at least some of the free zones.

9. Method as defined in claim 8, wherein at least some of the printed labels include a hologram.

10. Method as defined in claim 8,
wherein the adhering step includes using pressure sensitive adhesive to adhere the printed labels to the thermal transfer in the free zone.

11. Method as defined in claim 10, wherein the printed label includes a hologram, and wherein the hologram faces the carrier.

12. Method of making a composite thermal transfer, comprising:
providing a web of thermal transfers wherein at least some of the thermal transfers have reverse printing and free zones which are free of printing,
providing a web of printed labels,
and applying the printed labels to the transfers at least some of the free zones.

13. Method as defined in claim 12, wherein the applying step comprises dispensing the labels successively into the free zones.

14. Method as defined in claim 12, wherein the applying step comprises laminating the printed labels onto the transfers at their free zones.

15. Method as defined in claim 12, wherein the printed labels have heat-activatable adhesive on one side thereof and have pressure sensitive adhesive on the other side thereof to hold the printed labels to the transfer.

16. Method as defined in claim 14, including applying pressure to the printed label to improve adherence of the printed label to the transfer.

17. A composite thermal transfer, comprising:
a carrier having a release coating,
reverse printing over the carrier with at least one free zone which is free of printing,
adhesive over the printing except at the free zone(s), and
a printed label adhered in place over the free zone(s) and facing the carrier.

18. A composite thermal transfer as defined in claim 17, wherein the printed label is adhered in place by pressure sensitive adhesive.

19. A composite thermal transfer as defined in claim 17,
wherein the printed label includes a hologram.

20. A composite thermal transfer as defined in claim 17, including
a protective coating adhered to the release coating and wherein the printed label is adhered to the protective coating.

21. A composite thermal transfer as defined in claim 20, wherein the printed label includes a hologram.

22. A composite thermal transfer as defined in claim 20, wherein the adhesive comprises a heat-activatable adhesive.

23. A composite thermal transfer as defined in claim 22, including
pressure sensitive adhesive adhering the label in place.

24. A composite thermal transfer as defined in claim 20, including
pressure sensitive adhesive adhering the label in place.

25. A composite thermal transfer as defined in claim 24, including heat-activatable adhesive over the printed label.

26. In combination:
a carrier having a release coating,
a coating of pressure sensitive adhesive releasably adhered to the release coating,
a printed label adhered at one side to the pressure sensitive adhesive coating, and
a coating of heat-activatable adhesive at the other side of the printed label.

27. The combination defined in claim 26, wherein the printed label includes a hologram.

28. In combination:
a carrier having a release coating,
heat-activatable adhesive releasably adhered to the release coating, and a printed label adhered to the heat-activatable adhesive.

29. The combination defined in claim 28, wherein the printed label includes a hologram.

30. In combination:
a carrier having a first coating of pressure sensitive adhesive,
a release coating in contact with the pressure sensitive adhesive,
a coating of heat-activatable adhesive releasably adhered to the release coating,
a printed label having a printed side and an opposite side, the opposite side being adhered to the heat-activatable adhesive adhered to the printed side, and
a second pressure sensitive adhesive coating adhered to the printed side.

31. The combination defined in claim 30, wherein the printed label includes a hologram.

32. The combination defined in claim 30, including a release liner in contact with the second pressure sensitive adhesive coating.
